(19) United States
(12) Patent Application Publication
(10) Pub. No.: US 2002/0138748 A1
(43) Pub. Date: Sep. 26, 2002

(54) Code checksums for relocatable code

(76) Inventor: Andy C. Hung, Los Altos, CA (US)

Correspondence Address: COUDERT BROTHERS, Suite 3300, 4 Embarcadero Center, San Francisco, CA, 94111, US

(21) Appl. No.: 09/814,320

(22) Filed: Mar. 21, 2001

(51) Int. Cl. H04L 9/32

(52) U.S. Cl. 713/190

(57) ABSTRACT

A method for determining the integrity of an application program running on a computer system includes the preallocation of memory segments in the data portion for holding tables. Relocation addresses are selected and extracted from relocatable object programs, libraries and modules during translation and inserted into the tables. Additionally, a default address of a subprogram is selected and stored in the data portion. During execution of the application program, a run time reference address of the subprogram is determined and compared with the stored default address. If a match occurs, the reference address is used when performing a checksum of the application program. This occurs even for the situation of non-relocatable code. Otherwise, the reference address and the default address are used to offset the memory contents of relocation addresses stored in the tables for the purposes of performing a security application on the program. The security application has embodiments of code checksum or code decryption.

### FIELD OF THE INVENTION

The present invention relates generally to a method for determining the integrity of application programs having dynamically relocatable code executing on a computer system, and in particular, to extracting dynamic relocation information during the translation of source code programs into binary-coded object programs, and to making such relocation information available for use by security applications in the nature of code checksums and encryption routines.

### BACKGROUND OF THE INVENTION

The process of translating a program from its original source program into an object program so as to be executable by a computer system is conventionally known. Referring to the block diagram of FIG. 1, a typical translator 10 is shown. During the translation process, a program written in its original syntax, usually a high-level language, is translated into an equivalent program, which may be a low-level language for use by the computer. As is well-known, there are several specialized types of translators. For example, compiler 12 is a translator having a source program 14 written in a high-level language, and an object program (herein also referred to interchangeably as object code 16) being in machine language (i.e., binary format), or embodied in a reasonably suitable form for execution by the computer system. A compiler will typically examine the source program 14 to determine that the syntax and semantics contained therein is correct before translating it into a lower-level form. The compiler is typically specific to a particular programming language used and to the computer system onto which the program will execute.

By contrast, an assembler is yet another translator having object language being one of a variety of machine languages, but having a source program comprising a language that is substantially a transliteration of the object language and known as assembly language. A link editor (herein referred to interchangeably with a linker) is also a translator having a source program in machine language, but including relocation information. The linker links together a collection of relocatable programs that have been compiled separately, including subprograms stored in various program libraries (e.g., dynamically linked libraries or DLLs), into a single object program comprising machine code that may be executed by the computer system. The linker may either be a separate program or part of the compiler, and generally produces an output file. Additionally, a loader program (also referred to as a loader for the sake of brevity) is a type of translator, where the object program is in machine code, and where the source program is nearly identical, being a machine language program in relocatable form and containing tables of data addresses wherein the relocatable code requires modification to be executable by the computer system. With the loader program, one or more object programs (also referred to interchangeably as object files or modules) are loaded into memory, and control is transferred to a start address so as to initiate program execution. As shown in FIG. 1, the loader and linker may be represented in combination as a link-loader 18.

As will be appreciated by those skilled in the art, translation of especially high level source languages into executable programs comprising machine language, may often require multiple translations into some form of intermediate code. Accordingly, it is not uncommon for programs consisting of a source language to be compiled into assembly language, then assembled to produce relocatable machine code. As seen in FIG. 1, the contents of compiler 12 shown with the dotted lines are exemplary of this, known in the art, and therefore will not be described by individual components. Even further, the relocatable machine code may be link-edited and loaded into memory to obtain binary-executable machine code. The process of compilation, itself, may involve a multiple number of passes in order to progressively translate the source program into intermediate forms prior to producing the object code 16. Object code 16 is typically embodied in a file and is known as an object module (or module), which is in turn linked and loaded with libraries and other object modules that have been compiled separately. Together, the linking and loading of such object modules form the executable object program 20. Sometimes an object file will be generated from the compilation stage, wherein that object file is linked. This object program 20 will be otherwise referred to as an application program herein and may be executed on a computer system 22 similar to that shown in the block diagram of FIG. 2. Briefly, the executable object program includes at least a header section containing information about the structure of the program file, code section(s) having binary instructions that are executable by the computer system, data section(s), and a loader section. Therefore, depending upon the degree that the form of the object program becomes further removed in structure from the original source program, the translation process correspondingly may become more complex.

It is the dynamically relocatable characteristic of the object modules and libraries that is of concern to the present inventors. Programs, libraries and data enabled with dynamic relocation information no longer only reside in a usually fixed location in memory. Rather, the location can change depending on the application and operating system needs throughout program execution. This means that an application program may require some libraries at some time, and not necessarily all the libraries all of the time. Alternatively, the application program may require a library to be compiled at a later time. As such, not all libraries need to be compiled all at once. To this end, a random selection of libraries may be used so long as such libraries may be dynamically loaded at run time. Such libraries are conventionally known as dynamic link libraries (DLLs). Moreover, the libraries and programs are executable from any memory location, thus enabling memory locations to be reused for different applications and at various times. Accordingly, dynamic relocation is beneficial because it enables the decoupling of an application from some of its modules, each of which may be added at a later time and correspondingly complied at a later time. This provides for maximum flexibility when allocating memory for use by application programs, as the dynamic relocation prevents conflicts between segments of memory being concurrently used for different purposes. Those skilled in the art will recognize that one function performed by a loader is the checking of regions within the code segments to ensure that no conflicts arise. It is also conventionally known that one function of the linking stage is to resolve addresses within a program as well as with respect to standard libraries (e.g., operating system (OS) libraries, foundation classes).

In many instances, the dynamically linked libraries are provided by third-party vendors (e.g., Microsoft Corporation), and may often include default base addresses which are required by other libraries, thus resulting in a conflict between the various libraries. In one situation for example, a video decoder may be provided as a filter embodied as a software library, and may be instantiated by various third party applications (e.g., Microsoft DVD player). These third party applications will dynamically load the software library for the video decoder, and as seen in the system block diagram of FIG. 2, in those instances where multiple libraries use the same default address unbeknownst to the user, the libraries of the video decoder could potentially be in conflict with those addresses being used by the third party application. Without resolving such compatibility issues, a conflict in address locations sought by different software modules will likely have detrimental effects on the execution of the application program.

Still referring to FIG. 2, when the object modules and libraries are stored in external memory 24, like on a hard disk, the operating system 26 must load the object modules into the main memory 28 while converting address information contained within the object program to account for the relocation of the object modules outside of a fixed place in memory. A processor 30 (i.e., Central Processing Unit or CPU) facilitates these operations and enables system computations.

To accommodate the relocation information, additional space is allocated within the object format to describe the absolute address information that needs to be changed. For example, memory or jump label addresses will have to change if another program resides in the corresponding default address location. This in turn requires an additional offset to the entire absent address table (e.g., pushed to HEX 2000) so as not to conflict with a previously loaded library or the application itself. While it is true that some processors (e.g., Intel® processors) includes segments for enabling segment offset, and while other architectures rely upon page tables, all addresses are resolved within the program to ensure consistency within a code segment or a page table. Although it is possible to relocate a program once, when dealing with multiple libraries, it is not feasible to set one offset register to simultaneously function with every library. This situation results because reference to memory by a relocatable computer program application residing in RAM is dynamically resolved at load time although at the compile and link time; their exact locations cannot be guaranteed.

As also seen in FIG. 2, a monitor 32 provides a visual display of the computer system operation. A user interface 34 is used to monitor, modify and control the system, while an internal databus 36 permits information flow between an input/output controller 37, which in turn is coupled to input devices 38 and output devices 40. Also coupled to the internal databus 36 is a communication interface 42 that may extend communication outside of the system 22 to a network 44. As is known, an application program loaded into internal memory 28 will utilize a code portion 46, libraries 48 and a data portion 50.

When the dynamic relocation information associated with libraries and object modules has been modified and is no longer current, ascertaining its proper value when determining the integrity of the application program is particularly challenging and unsatisfactory according to techniques of the prior art. For example, a known security application is a checksum test (e.g., Cyclic Redundancy Check or CRC, parity check). Checksumming typically entails the addition of the contents stored in memory in order to obtain a total. This total is then compared with an expected value that has been stored in memory. If there is a match, then this signifies that the contents are valid and that the program operation is correct.

What the present inventors have realized is that conventional checksum techniques become problematic when performed with relocatable code that has been modified. For example, dynamic link libraries may be shared between multiple processes or may be loaded on-the-fly. This means that depending on how many other libraries were previously loaded, the location of a library may have changed. This modification may occur where code sections (used interchangeably with code segments) are shared and relocated by subsequent tasks sharing those code sections. Additionally, the modification may also occur by third party interference with the code and data sections. As a consequence, to perform a conventional checksum on such relocating code which has been modified is unsatisfactory because there are many segments within the code where the jump target address has become altered due to any of these modifications. Implementing a conventional checksum will produce meaningless results because the jump target address is not only no longer at a location determined at either compilation and linking, but is also no longer at a location based on an intended proper relocation. Since the target data is modified, determining the proper checksum using conventional techniques that do not consider relocation is impracticable. What is thus needed is a technique to make the dynamic relocation address available for those security applications used to determine the integrity of the application program. Therefore, it is desirable to be able to ensure that when checksum calculations are implemented, accurate and meaningful integrity checking of the executable application program results.

Additionally and to the extent that object files and libraries contain encrypted data, it would also be desirable to make such dynamic relocation address available for those security applications used to decrypt encrypted information. What is needed is a manner to decrypt previously encrypted modules and libraries on-the-fly, so that encrypted addresses that have changed may be decrypted with the proper relocation information. This result would ensure the integrity of the object file or module, but still prevent third parties from accessing the proprietary contents contained therein.

### SUMMARY OF THE INVENTION

Broadly stated, the present invention is a process and method for determining the integrity of an application program running on a computer system and having at least a data portion. In a preferred embodiment, the method comprises the steps of: pre-allocating one or more memory segments for holding tables, where the segments reside in the data portion; inserting tables in said segments; and executing the application program on the computer system using an operating system. The application program is produced by the steps of: linking one or more relocatable object modules with one or more libraries and other object modules to form an intermediate executable module, wherein the relocatable object modules are pre-compiled, and the libraries and the other object modules comprise relocation data; examining the relocation data to determine selected addresses, wherein said selected addresses correspond to address locations in the segments; storing the selected addresses in the tables; storing a default address of a selected subprogram in the data portion; and loading the libraries and the other object modules in the memory to transform the intermediate executable module into the application program executable by the computer system. The method further comprises the steps of: determining a reference address associated with a subprogram at run-time for the application program; comparing the reference address with a default address; and, executing a security application to determine the integrity of the application program based on the reference address and the selected addresses in the tables. The present invention may be stored, enabled and performed on a computer readable medium having computer-executable instructions functioning on a computer system.

One objective of the present invention is to make available to the security application the relocation information of the object modules and libraries. The present invention accomplishes this by: (1) pre-allocating space in the data portion; and (2) pre-inserting tables into the pre-allocated space in the data portion of the object module after the linking process has begun. The present invention stores the relocation information, namely the jump address locations, in the tables during the translation process in order to make them available for subsequent use in the event that the jump addresses have been changed.

An important technical advantage of the present invention is that it eliminates the problems associated with conventional security applications being performed on information that is valid at compile and/or load time, but which does not account for address changes caused by modification of such relocation information.

Another technical advantage of the present invention is the detection of whether the jump address has changed by saving a default address of a subprogram in the data portion, post-compilation, but during the linking process. This default address can then be compared with a corresponding address for the subprogram determined at run-time and during the execution of the security application. If the value of each of these addresses is the same, then no modification has occurred. However, if it is different, then a modification has occurred and the jump address can be ascertained by using the relocation information saved in the tables to offset the run-time address location.

The present invention is applicable to extracting dynamic relocation information during the translation of source code programs into binary-coded object programs and to making such relocation information available for use by security applications. In the preferred embodiment, the present invention may be used with security applications in the nature of code checksums, which are run on code segments by reading data therein.

In an alternative embodiment, the present invention may be used with security applications in the nature of decrypting a previously encrypted code segment or data by reading and writing back to the same code segment or data. This is accomplished by similar steps recited in the preferred embodiment, except that prior to the step of determining a reference address associated with the sub-program at run-time for the application program, the method includes the step of modifying one or more portions of segments by encryption.

One useful application of enabling dynamic relocation information for use by security applications, either through code checksums or through the decryption of previously encrypted information, is the detection of third party interference with executable object program applications where break points are deliberately inserted into the code to determine its operation and functionality. By detecting such modifications in the code that are not necessarily due to error, but to third party tampering of the code, the integrity and validity of the code may be ascertained.

Another important technical advantage of enabling relocation information for use by security applications used with decrypting encrypted information on-the-fly is the prevention of third parties from reverse engineering programs or code through disassembly.

These and other objects and resulting advantages of the present invention will become apparent from the attached drawings, the following detailed description of the invention, and the appended claims.

### BRIEF DESCRIPTION OF THE DRAWINGS

FIG. 1 is a functional block diagram of the process steps for translating source programs comprising a plurality of instructions into an object program executable by a computer system according to the prior art.

FIG. 2 is a block diagram of an exemplary computer system used by the present invention.

FIG. 3 is a flowchart of the process steps of the present invention for determining the integrity of an application program executable on the computer system of FIG. 2, and according to a preferred embodiment of the present invention.

FIG. 4 is a flowchart of the process steps for producing an executable application program according to the present invention by inserting relocation information into tables within the data portion.

FIG. 5 is a flowchart of the process steps for executing a security application to determine the integrity of the application program using relocation information.

FIG. 6 is a flowchart of FIG. 3 modified to include the encryption of data with a code portion according to an alternative embodiment of the present invention.

### DETAILED DESCRIPTION OF THE INVENTION

The present invention comprises a process for determining the integrity of an application program by making available the relocation addresses of dynamically relocatable object modules and libraries to a security application performed on the executing application program. It should be noted that the application program is embodied as an executable file, or as multiple modules that are necessary to implement the functionality of the program. Since the file and the modules may all be processed in accordance with the present invention, such terms will sometimes be used interchangeably in the following description.

The present invention post-processes the initial output of the linker during the translation of pre-compiled relocatable object modules into the application program. To this end, relocation information associated with dynamic link libraries and modules is saved in preallocated tables located in the data portion of memory post-execution or post-linking. This first round of processing is done prior to the loading process and to producing the executable application program. Once all information has been loaded, the application program may execute on the computer system. During the run time (i.e., execution) of the application program, the present invention includes a second round of processing involving the implementation of a security application for determining the integrity of an application program. In the preferred embodiment of the present invention, this security application is a checksum routine. In an alternative embodiment of the present invention, the security application is a decryption routine. An important technical advantage provided by the present invention is the ability to detect whether addresses within the code or data sections have been modified as a result of the loading process or as a result of third party tampering. In turn, the present invention provides the security application with the relocation information stored in the preallocated tables, so that the security routine may offset the modified addresses with the proper relocation information on-the-fly.

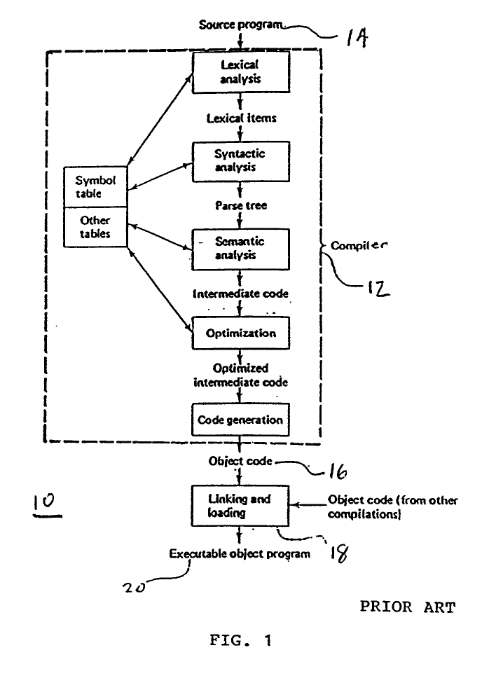

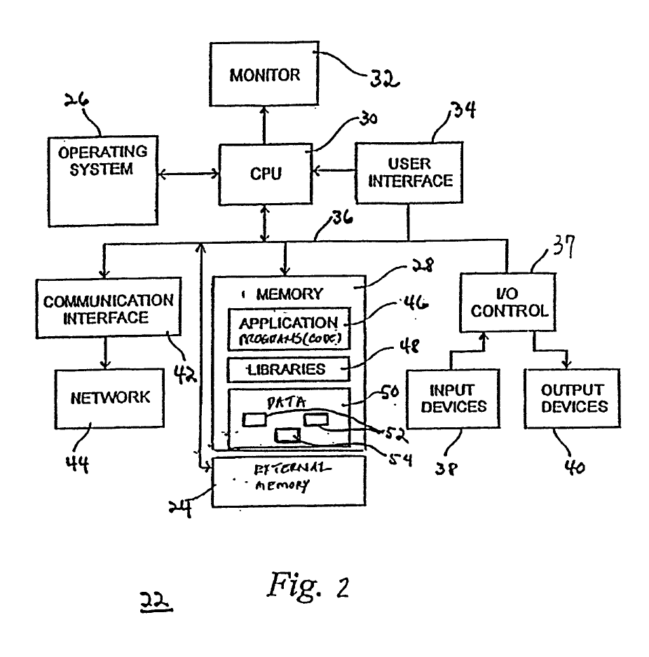

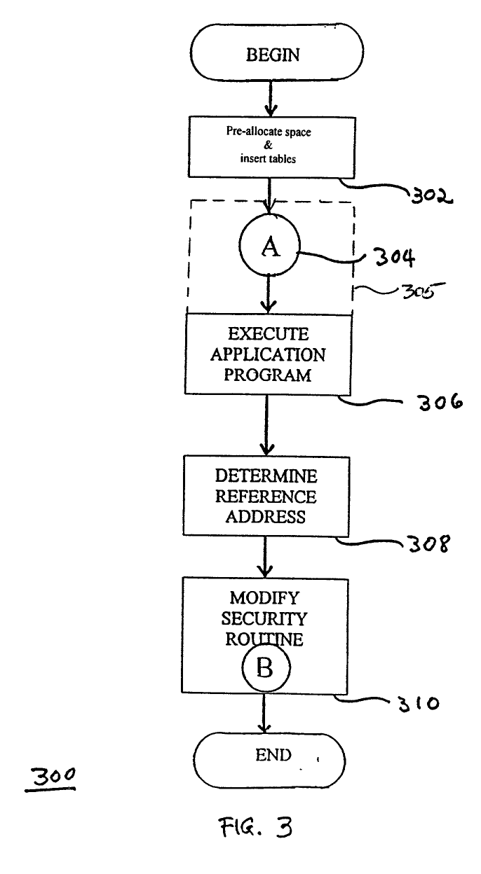

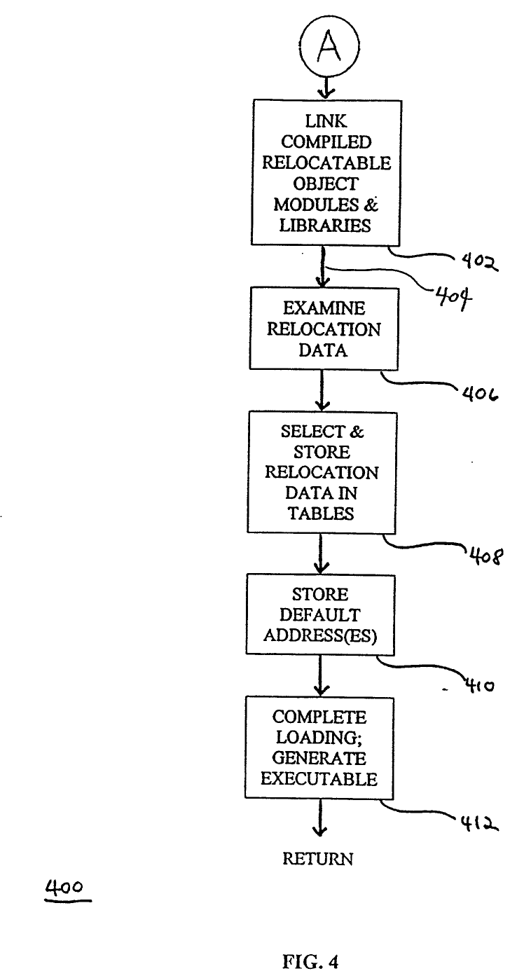

The method for determining the integrity of an application program will be described with reference to the flowchart 300 of FIG. 3. However, it should be noted that the following description will often make reference to FIGS. 1-2. In a first step 302, pre-sized tables 52 are preallocated and inserted into the data portion 50 of memory 28. Next, step 304 represents the process of producing the application program by translating a plurality of source instructions into an object module and post-processing the object module once the linking process has begun. To explain step 304, reference will be made below to process 400 outlined in FIG. 4, which is necessary prior to the execution of the application program 306 to be described below. Because process 400 must be completed prior to execution of the application program, it is shown in phantom box 305 as preceding the execution process 306

Referring back to FIG. 3, in step 304, the linking process begins, and during this final stage of translation, pieces of code resulting from separate translations of subprograms are united into a final executable application program similar to the executable object program 20. Turning for a moment to FIG. 1, the difference between the final executable object program 20 (FIG. 1) and the object modules 16 resulting from the preceding translation phases is that the latter comprises executable programs in near final form, except where the programs make reference to data and subprograms located external to memory. Accordingly, there are incomplete portions specified within the code or data portions to be attached by loader tables produced by the translator. In the linking and loading phase 18, the various segments of translated code are loaded into memory, and the attached loader tables are used to properly link these segments together properly by inserting data and subprogram addresses into the code as necessary. Once this occurs, the resulting final executable object program or dynamic link library 20 is ready to run on the computer system 22.

As shown in the flowchart of FIG. 4, at step 402, the present invention assumes that the source instructions have been pre-compiled to produce an object module similar to the object code 16 as shown in FIG. 1. The linking of object modules to libraries is completed. During this linking process and prior to the loading of the attached tables, the present invention post-processes an initial output 404 of the linking process 402, otherwise representing an intermediate executable module. Next, the present invention will examine the relocation information associated with the dynamic link libraries and object modules, as shown in step 406. This step entails extracting from the object modules or DLLs the relocation information after the linking process has begun and before producing the final executable program. Typically, the linking process generates the relocation information that is stored in the object modules and DLLs. The present invention will subsequently make this relocation information available to the security application by first examining and selecting relocation addresses of interest, and second by storing the selected addresses in the tables 52 that have been pre-allocated in the data portion, as indicated in step 408. These selected addresses may comprise memory references or jump target addresses. Alternatively, the address locations stored in the tables may be stored in a compressed and encrypted manner. Even further, it will be appreciated that even the difference between two subsequent addresses corresponding to locations in the code segment may be stored in memory (e.g., it is recognized that there may be a jump address for every 64K byte of memory). As will be described in more detail later, the checksum routines will be able to access the proper relocation information including the program jump addresses, which have been determined during the compilation, resolved during linking, but modified during loading or by a third party.

It should be noted that the ability of the present invention to keep track of dynamic address changes is paramount in accurately ascertaining the integrity of the application program. Moreover, the ability of the present invention to detect when addresses have been modified is advantageous because it provides conventional checksum programs with the proper jump addresses on-the-fly. As is known, once the loading process is complete, the relocation information is no longer readily available. When the executable program application is generated, the code is bound at a default base address of the library during the linking and loading process. As shown in step 410, one or more of these default base addresses associated with particular subprograms are selected and stored in memory segments 54 residing within the data portion 50. As will be seen later, these default addresses will provide a base address value for enabling the present invention to determine the proper jump address when the checksum calculations are performed. As is also known, in the absence of any other libraries being loaded at a particular location, the loader will use the address associated with the library during loading, and will otherwise use a relocation address. It will be understood by those skilled in the art that step 410 may be implemented by determining and storing a default function address of well-known sub-programs, which may be comprised of one or more procedures or functions (e.g., & procname, using the C programming language). In step 412, the loading process is implemented and the executable application program is generated. This means that the loading of DLLs and other modules in memory will enable the intermediate executable module to be transformed into the application program to be executed by the computer system. When the application program is loaded into memory (e.g., RAM) for execution, it is known that the application loader is aware of allocated memory locations of the application. The relocation information comprises the memory address locations that must be changed upon relocation. The loader will determine the appropriate reference values that should be in the application code section and write such reference values into the external references that may include calls to functions provided by the operating system. The loader then uses the starting address of the code or data sections in which to reference objects of that particular section. In concluding the process 400, a return is made to the calling module 304 of FIG. 3.

Referring back to FIG. 3, in step 306, the application program is executed on the computer system 22. In step 308, a reference address of a sub-program, library, subroutine, procedure or function to be executed is determined at run-time. As will be explained below, this reference address will be compared to the default function address, and using the information gained from this comparison, the security application will be performed as indicated by step 310.

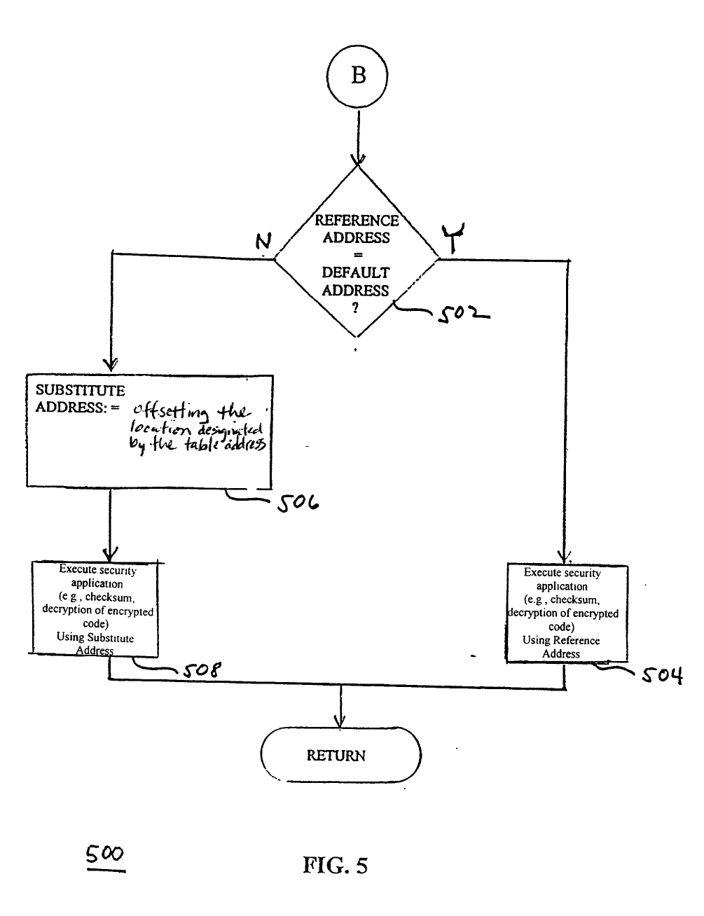

Step 310 of FIG. 3 will be explained with reference to the process 500 shown in the flowchart of FIG. 5. In step 502, processor 30 determines if the reference address is equal to the default address. As will be explained below, if the default address equals the reference address, then no relocation has occurred. However, if these addresses are unequal, then the base address has changed.

For example, if these values are equal, the security application is implemented as in step 504. This means that the jump address has not been modified and that the security application may be implemented with the reference address. In a preferred embodiment, the security application entails a checksum that when executed may be calculated on the loaded application program stored within internal memory using the reference address found in the code portion. Those skilled in the art will readily see that step 504 is directly applicable for non-relocating code which has not been modified by third party influence nor intentional relocatable code. If the checksum value is valid, then integrity of the application program is verified. It will be appreciated that other modules may be executed to determine the integrity of the application program based on the reference address and those selected addresses stored in the tables.

However, if the reference address is unequal to the default address, a substitute address must be calculated as in step 506. The calculation of the substitute address accounts for the code being modified during the loading process or by a third party. The substitute address comprises applying an offset to the location found at the corresponding selected address stored in table 52 in the data section. The tables store the memory locations where the offsets need to occur at in some format or another (e.g., at this location, add or subtract the offset). More specifically, the tables provide a location within the code segment, and the code segment indicates the address location in which to apply the offset (i.e., the table enumerates every address location within the code segment, and present invention modifies such locations in the code segment by an offset). As will be appreciated by those skilled in the art, this offset may be found by subtracting the default address from the reference address. Hence, the substitute address for the original address found at the memory location determined by the selected address is given by Equation (1):

Substitute address=(original address)+(reference function address)−(default address) (1)

Those skilled in the art will also readily appreciate that a variety of other techniques for determining the offset value may be used with the present invention. In FIG. 5, the security application may be implemented using the substitute address, as in step 508. More specifically, this means that a checksum may be calculated on the loaded application program stored within internal memory by using the substitute address instead of the reference address found in the code portion. In concluding the process 500 of FIG. 5, a return is made to the calling module 310 of FIG. 3.

The invention is especially useful for running dynamic checksum applications for determining the validity of the contents that constitute the checksum test. Additionally, a checksum technique may also be used to verify the that the operation of circuitry is proper. The process steps disclosed herein can be advantageously employed using a variety of formats for the executable application program, including the formats known as XCOFF and ELF.

The invention offers a multitude of benefits, for example in ensuring that an operating system is stable and is running properly with the use of a checksum, and if it is not, then it might be recommended that the operating system be reloaded.

While running the checksum on the code segment by reading data therein is a preferred embodiment for executing the security application by applying the principles discussed here, to a large extent, third parties have a much easier time ascertaining and reverse-engineering unencrypted code. Checksums to a large extent defeats debugger type analysis, tracing and or real modifications to the code. But if third parties extract bits and pieces of the code, it is difficult to detect and to cure this by checksumming, and so encryption provides another barrier to this type of invasion.

In an alternate embodiment of the present invention, the inventors have realized that one reason for running a static disassembler on code is to ensure that the code is running properly, while another less-desirable motivation for running a static disassembler on code is to ascertain what functions the code is performing. This is especially problematic when third parties desire to understand the functions of the code in an unauthorized context. Accordingly, a key advantage to encrypting code is the prevention of third parties from obtaining access to proprietary information (e.g., trade secrets) contained in the code. When code is scrambled, it is more difficult for third parties to access such confidential information. With the encryption and decryption of the code on-the-fly, one cannot ascertain a consistent set of code data residing in memory at the same time because certain locations within the code may have not been descrambled (e.g., by possibly another call routine before a jump occurs). Moreover, encrypted code is one means to prevent third parties from breaking into the program by reverse engineering through any type of disassembly (e.g., run-time disassembly via a debugger or static disassembly). It is thus desirable to provide the relocation information to encrypted code when decryption occurs.

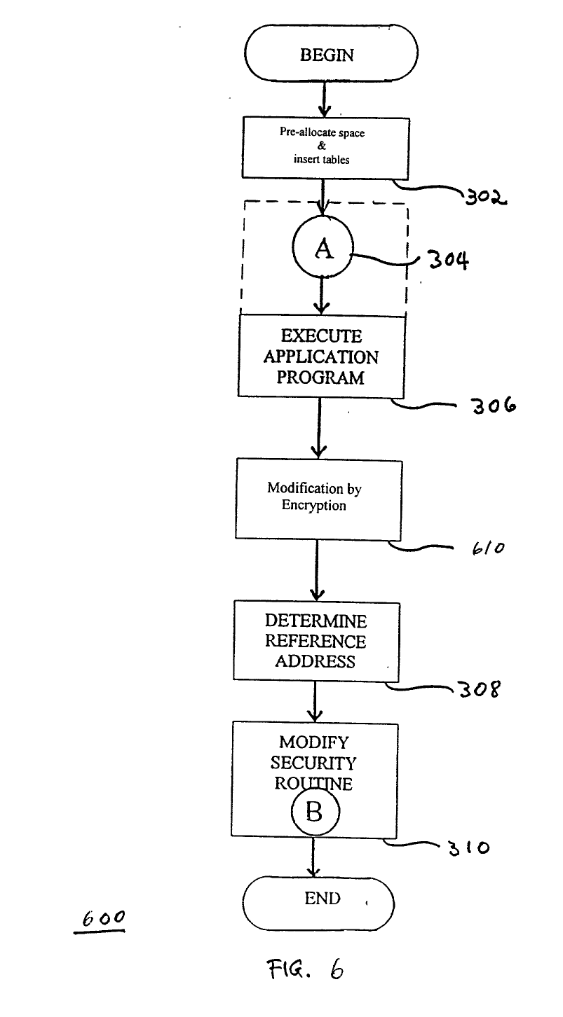

The present invention is readily adaptable to running a security application where the code segment may be modified so that it may then be possible to decrypt a previously encrypted code segment by reading and writing back on-the-fly to the same code segment. Since encrypted code segments may also be modified, relocation data is still required for accurate decryption, because when the information is loaded into the code segment, the linker has changed the encrypted addresses. Referring to the flow chart of FIG. 6, an alternate embodiment of the present invention is shown. FIG. 6 is substantially the same as FIG. 3, except for the inclusion of step 610 directed to modifying one or more portions of code segments by encryption. The present invention of FIG. 3 may be easily adapted to include the encrypted data with a code portion (i.e., code segment also known as a text segment), that is, that part of the code, wherein if the program is run more than once, that part of the code would be shared in memory by multiple instantiations of the program.

In FIG. 6, when step 310 is reached, the execution of a security application entails the decryption of a code portion by using differences as computed between the reference address and the default address. What this means is that the decryption of the sum of an encrypted object plus an offset does not equate to the decryption of an encrypted object with an offset added thereto. This is represented by the following inequality:

decryption(encrypted(object)+offset)<>decryption(encrypted(object))+offset (2)

To this end, step 508 must account for the offset provided by the loader to the encryption provided by step 610. Accordingly, the decryption done by step 508 is performed by subtracting the offset provided by the loader, then performing the decryption, and then adding the loader offset afterwards. This is shown in Equation (3):

decryption((encrypted(object)+offset)−offset)+offset (3)

This results in the same data that would have been achieved had an encryption not be applied. The following examples will illustrate generally when certain types of security applications are preferable.

With the above-described embodiments of the present invention, those readily skilled in the art will see its applicability to a variety of uses, including for example, its use with Digital Versatile Disc (DVD) playback applications, wherein each DVD disk includes a copy protection scheme thereon, in the form of encrypted data. More specifically, motion pictures contained on a DVD disk are protected from unauthorized copying using a technology called Content Scramble System (CSS). CSS functions as an encryption scheme that permits a DVD player which has been configured properly to read and play, but not copy the digitized images of the motion picture contained on the DVD disk. When conventional DVD players operate, they receive encrypted information from the DVD and decrypt such information prior to displaying the video and producing the audio signals. Hackers will attempt to insert their own splice or jump point within the encrypted data to ascertain the content of the plain text and to determine how the software operates. An important technical advantage provided by the present invention is that it may be used to detect third party intrusion to obtain the encrypted data from a DVD disk. In particular, where the third party places break points within the software to see how the software operates or to read the content of the information stored thereon, the modification in at least the code section may be detected with the present invention. The invention is especially useful for preventing unauthorized access to encryption keys associated with the application program. This prevents third party unauthorized misappropriation of the digital identity of the particular software provider.

Another advantage provided by the present invention is that it will allow the user to examine the object code and to ascertain whether or not it has changed, for example, by someone placing a jump point therein, by someone tampering with the program or by a hardware failure corrupting the program. It will become apparent to those skilled in the art that often times when the cause of the corruption to the code stems from a hardware failure, the code may not function at all or may cause dangerous and possibly catastrophic failure if run at all (e.g., crashing a computer, fatal in life support systems operated by computers). In this situations, it would be undesirable to run the code due to the potential deleterious effects.

A key purpose of encryption is to prevent third parties from discovering proprietary information. Often these third parties have a few purposes in mind, namely: (1) natural curiosity; (2) break into code and modify it; (3) using programs in a manner that is not licensed to be used (e.g., with DVD, owners want to protect the content); and (4) learning the trade secrets of companies by breaking into the code. Opportunities for such third parties to engage in these behavior may exist when they have a copy of a program, a DVD ROM, and with evaluation copies of program transmitted online over the Internet to potential customers containing timeouts or some other limitations in the nature of restricting the operation and use of the program for evaluation purpose (e.g., not being able to play longer than five minutes, or limiting the evaluation to thirty days and disengaging the software thereafter). Third parties will often use these types program to discern what places in the code call or invokes some timer or kernel function, and will want to make a modification to such restriction so as to deactivate it. Often, many companies place their trade secrets in their programs, which they do not necessarily desire third parties to discern. There are also some forms of authentication that people will attempt to discern and imitate so that they may forge their identity and infringe upon the good will developed by the source providing associated goods or services.

While the present invention has been particularly described with respect to the illustrated embodiments, it will be appreciated that various alterations, modifications, and adaptations may be made based on the present disclosure, and are intended to be within the scope of the present invention. While the invention has been described in connection with what is presently considered to be the most practical and preferred embodiments, it is to be understood that the present invention is not limited to the disclosed embodiments, but to the contrary, is intended to cover various modifications and equivalent arrangements that are within the scope of the appended claims.

What is claimed is:

1. A method for determining the integrity of an application program running on a computer system having a memory, said application program having at least a data portion residing in the memory, the method comprising the steps of:
(a) pre-allocating one or more segments in said data portion;
(b) inserting tables in said segments;
(c) executing said application program on said computer system using an operating system, said application program produced by:
(c1) linking one or more relocatable object modules with one or more libraries and other object modules to form an intermediate executable module, said relocatable object modules being pre-compiled, and said libraries and said other object modules comprising relocation data,
(c2) examining said relocation data to determine selected addresses, said selected addresses corresponding to address locations in said segments,
(c3) storing said selected addresses in said tables,
(c4) storing a default address of a selected subprogram in said data portion, and
(c5) loading said libraries and said other object modules in said memory to transform said intermediate executable module into said application program executable by said computer system;
(d) determining a reference address associated with said selected subprogram at run-time for said application program;
(e) comparing said reference address with said default address; and
(f) executing a security application or module to determine said integrity of said application program based on said reference address and said selected addresses in said tables.

2. The method of claim 1, wherein said step (f) uses said reference address if said reference address is equal to said default address.

3. The method of claim 1, further comprising the step of computing a substitute address by offsetting memory locations of said selected addresses stored in said tables for every selected address.

4. The method of claim 3, wherein said step (f) uses said substitute address if said reference address is unequal to said default address.

5. The method of claim 3, wherein said selected addresses are offset by adding or subtracting an offset to said selected addresses.

6. The method of claim 1, wherein said selected addresses are selected from a group consisting of memory references and jump target addresses, and said subprograms are selected from a group consisting of functions, subroutines, procedures and libraries.

7. The method of claim 1, wherein said security application is a checksum application.

8. The method of claim 1, wherein said security application decrypts previously encrypted data.

9. The method of claim 8, wherein said data is encrypted while said tables are being inserted.

10. The method of claim 1, wherein said application program comprises encrypted data residing on a DVD disk.

11. A computer system, comprising:
a central processing unit;
memory accessible by the central processing unit;
at least one application program executable on said central processing unit and within said memory; and
means for determining the integrity of said application program according to a method as described in claim 1.

12. The computer system of claim 11, wherein said step of executing a security application uses said reference address if said reference address is equal to said default address.

13. The computer system of claim 11, further comprising the step of computing a substitute address by offsetting memory locations of said selected addresses stored in said tables for every said selected address.

14. The computer system of claim 11, further comprising the step of storing said selected addresses in a compressed and encrypted format in said tables.

15. The computer system of claim 13, wherein said step of executing a security application is based on using said substitute address if said reference address is unequal to said default address.

16. The computer system of claim 11, wherein said application program comprises encrypted data residing on a DVD disk.

17. A computer readable medium having computer-executable instructions, which when executed on a computer system, causes said computer system to determine the integrity of an application program running on said computer system, said application program having at least a data portion residing in memory, said computer-executable instructions causing said computer system to perform the steps of:
(a) pre-allocating one or more segments in said data portion;
(b) inserting tables in said segments;
(c) executing said application program on said computer system using an operating system, said application program produced by:
(c1) linking one or more relocatable object modules with one or more libraries and other object modules to form an intermediate executable module, said relocatable object modules being pre-compiled, and said libraries and said other object modules comprising relocation data,
(c2) examining said relocation data to determine selected addresses, said selected addresses corresponding to address locations in said segments,
(c3) storing said selected addresses in said tables,
(c4) storing a default address of a selected subprogram in said data portion, and
(c5) loading said libraries and said other object modules to transform said intermediate executable module into said application program executable by said computer system;
(d) determining a reference address associated with said selected subprogram at run-time of said application program;
(e) comparing said reference address with said default address; and
(f) executing a security application or module to determine said integrity of said application program based on said reference address and said selected addresses in said tables.

18. The computer readable medium of claim 17, further comprising the step of computing a substitute address by offsetting memory locations of said selected addresses stored in said tables for every said selected address, said step of executing a security application being based on using said substitute address if said reference address is unequal to said default address.

19. The computer readable medium of claim 17, wherein said step (f) is based on using said reference address if said reference address is equal to said default address.

20. A method for determining the integrity of a relocatable application program executable on a computer system, said program being generated from one or more precompiled object files, said computer system including memory and said application program having at least a data space residing in said memory, said method comprising the steps of:
(a) inserting tables into pre-allocated memory segments residing in said data space;
(b) examining relocation data for selected addresses when said pre-compiled object files are linked and loaded with one or more libraries and other object files, said libraries and said other object files comprising said relocation data;
(c) storing said selected addresses in said tables;
(d) storing a default address in said data space, said default address being associated with a point of reference within said pre-complied object files;
(e) determining a reference address from said application program at run time, said reference address corresponding to said point of reference;
(f) comparing said reference address with said default address; and
(g) performing a checksum to determine said integrity of said application program based on said reference address and said selected addresses in said tables.

21. The method of claim 20, wherein said step of performing a checksum is based on using said reference address if said reference address is equal to said default address.

22. The method of claim 20, wherein said step of performing a checksum is based on using a substitute address if said reference address is unequal to said default address, said substitute address being computed by offsetting memory locations of selected addresses for every selected address.

23. The method of claim 22, wherein said offsetting is done by subtraction or addition.

24. The method of claim 20, wherein said application program comprises encrypted data residing on a DVD disk.

25. A computer readable medium having computer-executable instructions, which when executed on a computer system may encrypt and/or decrypt a portion of an application program enabled to run on said system, and causes said computer system to determine the integrity of said application program having at least a data portion residing in memory, said computer-executable instructions causing said computer system to perform the steps of:
(a) pre-allocating one or more segments in said data portion;
(b) inserting tables in said segments;
(c) executing said application program on said computer system using an operating system, said application program produced by:
(c1) linking one or more relocatable object modules with one or more libraries and other object modules to form an intermediate executable module, said relocatable object modules being pre-compiled, and said libraries and said other object modules comprising relocation data,
(c2) examining said relocation data to determine selected addresses, said selected addresses corresponding to address locations in said segments,
(c3) storing said selected addresses in said tables,
(c4) storing a default address of a selected subprogram in said data portion, and
(c5) loading said libraries and said other object modules to transform said intermediate executable module into said application program executable by said computer system;
(d) modifying one or more portions of said segments by encryption;
(e) determining a reference address associated with said selected subprogram at run-time of said application program;
(f) comparing said reference address with said default address; and
(g) executing a security application or module to determine said integrity of said application program based on said reference address and said selected addresses in said tables.

26. The computer medium of claim 25, wherein said method prevents access to encryption keys associated with said application program.

27. The computer medium of claim 25, wherein said step of modifying one or more portions of said segments by encryption comprises the step of (a) adding or subtracting memory locations of said selected addresses in the encrypted object; (b) performing decryption; and (c) adding or subtracting memory locations of said selected addresses after decryption.
